(19) United States
(12) Patent Application Publication
(10) Pub. No.: US 2024/0246050 A1
(43) Pub. Date: Jul. 25, 2024

(54) MIXING GRANULATOR

(71) Applicant: DIOSNA Dierks & Söhne GmbH, Osnabrück (DE)

(72) Inventor: Henrik OEVERMANN, Quernheim (DE)

(21) Appl. No.: 18/100,197

(22) Filed: Jan. 23, 2023

(51) Int. Cl. B01J 2/10

(52) U.S. Cl. CPC B01J 2/10; B01J 2219/0295; B01J 2219/185

(57) ABSTRACT

A mixing granulator includes a container to receive a product, a mixing tool located in the container and seated on a vertically aligned shaft, and a comminuting tool located in the container. At least one of the container, the mixing tool or the comminuting tool is at least partially made of plastic or a plastic composite material.

### BACKGROUND OF THE INVENTION

### 1. Field of the Invention

The present invention relates to a mixing granulator, a use of a mixing granulator, a container, a use of a container, and a method for granulating with a mixing granulator.

### 2. Description of the Related Art

Mixing granulators or also batch mixers have a fixed container into which a vertically aligned drive shaft projects, on which a mixing tool is mounted. The mixing tool has the task of mixing a powder with aggregates. Granulating liquid can optionally be added to the mixed material. A comminution tool projects laterally into the container. The comminution tool, sometimes also called a shredding tool or generally a size reduction tool, breaks up lumps and compacts the moistened mix. The container may have a discharge opening through which the container can be emptied while the mixing tool is running. However, it is also known to remove the container from the device for emptying.

Mixing granulators are essentially formed of stainless steel. Mixing granulators can be multi-purpose devices. If valuable or toxic substances are processed in such multi-purpose devices, a cleaning validation must be carried out. For any cleaning validation, a risk-based consideration of all substances that may enter the downstream product must be made. This includes residues of active ingredients, cleaning agents and possible degradation products. Acceptance criteria are defined to avoid possible cross-contamination in the downstream product.

For many substances in pharmaceutical applications, limit values of OEB 5 must be observed to effectively protect operators from consequential damage.

The abbreviation OEB stands for “Occupational Exposure Band” and provides information about the hazard potential of a substance. The OEB value describes the toxicology of the pure substance. For illustration purposes, OEB 5 is given here as an example. OEB 5 corresponds to an exposure of <1 mg/m³ (micrograms per cubic meter). An example of such an application includes use of highly active ingredients, also called High Potency Active Pharmaceutical Ingredients (HPAPIs), which are often toxic. These active ingredients have at least one of the following criteria: highly effective (therapeutic doses of less than 0.5 mg/day), significant adverse effects (life-threatening, irreversible, or strongly sensitizing) even at low doses, and/or genotoxic or carcinogenic or have reproductive effects at relevant doses.

Examples of such agents include Vincristine, Doxorubicin, Gemcitabine, and Bleomycin.

Highly active ingredients are processed in so-called high-containment applications that comply with the OEB 5 limit.

### SUMMARY OF THE INVENTION

Example embodiments of the present disclosure provide mixing granulators which can each be used simply and inexpensively.

Example embodiments of the present disclosure provide novel mixing granulators, methods of using mixing granulators, containers, methods of using containers, and methods for granulating with mixing granulators.

Accordingly, a mixing granulator is provided with a container for holding a product, a mixing tool located in the container and seated on a vertically aligned shaft, and a comminuting tool located in the container. At least one of the container, the mixing tool, or the comminuting tool is at least partially made of a plastic or a plastic composite material.

Product-contacting components are components that come into contact with the product. These are also referred to as components that come into contact with the product. The components may include at least one or more of the container, the mixing tool, or the comminuting tool, but are not the only components that come into contact with the product. It was already known, for example, to manufacture a lid of the container or also sealing devices at least partially from plastic. The components listed above have so far been made exclusively of stainless steel.

The fact that the at least one component in contact with the product is at least partly made of plastic or a plastic composite material means that production is significantly cheaper than with conventionally used stainless steel. A single use is thus possible, whereby a cleaning validation can be at least partially omitted. It is conceivable that only the container is the at least one component in contact with the product. Particularly preferably, all the components mentioned in the list are at least partially formed from a plastic or a plastic composite material.

The container preferably includes a first region to receive the product and including a container wall and a bottom, including an opening for the shaft and an adjoining connecting region which surrounds a coupling located between a drive and the shaft. As a result, a flange for the comminution tool is located in the container wall in the first region. In addition, an outlet to remove the product may be provided in the container wall. The container preferably has a unitary structure made of a plastic or a plastic composite material. In particular, the container is at least partially formed in an injection molding process.

The plastic or plastic composite is preferably food safe.

The mixing tool preferably includes blades, and the comminution tool is substantially u-shaped. It is also conceivable that the comminuting tool is 2-u-shaped or shaped as a fir tree-shaped chopper and the like. It is advantageous if the axis of rotation of the comminution tool is perpendicular or substantially perpendicular to the axis of rotation of the mixing tool.

The mixing granulator can include a base, preferably in the form of a base cabinet, which covers the drive of the mixing tool as well as a drive of the comminution tool. In particular, the mixing granulator is a table-top unit. The substructure is preferably made of stainless steel.

It is particularly advantageous if the container is connected to the substructure by a connection, in particular, a bayonet connection, which can be released manually without tools, or, more generally, if the container is designed to be removable and the container can be connected to the substructure by a bayonet connection.

The first region of the container is preferably sealed off from the outside by a seal that seals the mixing tool and the comminution tool.

Furthermore, a use of a mixing granulator as previously described for mixing pharmaceutical powder with aggregates is provided, in particular in a high containment application.

Furthermore, a container mixing granulator includes a first portion to receive a product, including a container wall and a bottom, including an opening for a shaft of a mixing tool, and an adjoining connecting region, wherein the container includes a flange for the comminution tool in the container wall in the first region and an opening with a rim opposite the base. The container is at least partially made of a plastic or a plastic composite material.

This has the advantage that the container can be manufactured particularly inexpensively and is therefore suitable for single use.

In addition, use of the container is envisaged for a mixing granulator mixing pharmaceutical powder with for aggregates, particularly in a high containment application. The container may further include an outlet for removal of the product. The container is preferably formed at least in part by an injection molding process. It is advantageous if the container is formed in one piece from plastic or plastic composite material.

In addition, a method is provided for mixing, in particular granulating, substances with a mixing granulator described above, the method including placing the substances in the container, mixing the substances in the container via the mixing tool, removing or discharging the product from the container, discarding, and replacing the at least one component in contact with the product when a cleaning process is necessary to prevent cross-contamination.

By disposing the at least one product contacting component, cleaning validation is significantly simplified or completely eliminated. In a preferred embodiment, the process is a high containment application and the at least one product contacting component includes the container. When the comminution tool is required in the process, particularly when liquid is added, the process includes rotating the comminution tool.

The above and other elements, features, steps, characteristics and advantages of the present invention will become more apparent from the following detailed description of the preferred embodiments with reference to the attached drawings.

### BRIEF DESCRIPTION OF THE DRAWINGS

Preferred embodiments of the present invention are explained in more detail below with reference to the drawings. Identical or functionally identical components are provided with the same reference signs across the figures.

FIG. 1 shows a spatial view of a mixing granulator.

FIG. 2 shows a longitudinal section through the mixing granulator of FIG. 1.

FIG. 3 shows a longitudinal section through a container of the mixing granulator of FIG. 1.

FIG. 4 shows a spatial view of the container.

### DETAILED DESCRIPTION OF THE PREFERRED EMBODIMENTS

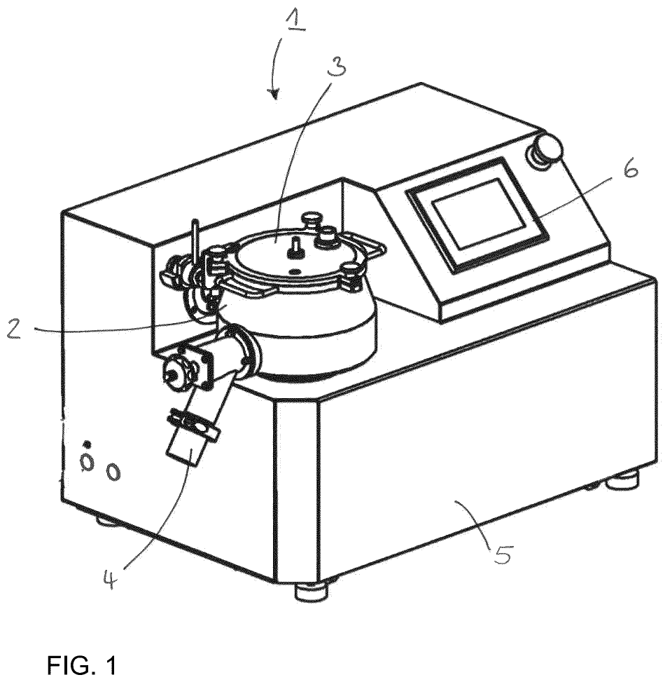

FIG. 1 shows a mixing granulator 1, which is designed as a tabletop device and enables mixing, granulating, and pelletizing in the development of solid oral dosage forms. The mixing granulator 1 includes a container 2 with a lid 3. An outlet 4 is provided in the lower lateral region of the container 2. A three-bladed mixing tool, which is not shown, is provided in the container 2. Furthermore, a not shown comminution tool in the form of a chopper is provided, which is located inside the container 2 and is driven for rotation by a drive shaft via a drive coupling. Furthermore, the mixing granulator 1 includes a substructure 5 made of stainless steel. The substructure 5 is preferably mobile and includes four swivel casters. It can also include feet. The base 5 covers the drive of the mixing tool and the drive of the comminution tool, and an operator unit 6 is inserted into the base 5, via which an operator can control and monitor the mixing granulator 1. The mixing granulator 1 is preferably dimensioned such that it can be placed on a table. The size of the mixing granulator 1 depends on the capacity of the container 2. The container capacity is preferably between about 0.25 liters and about 6 liters. The mixing granulator 1 can produce dry mixes and moist granulates.

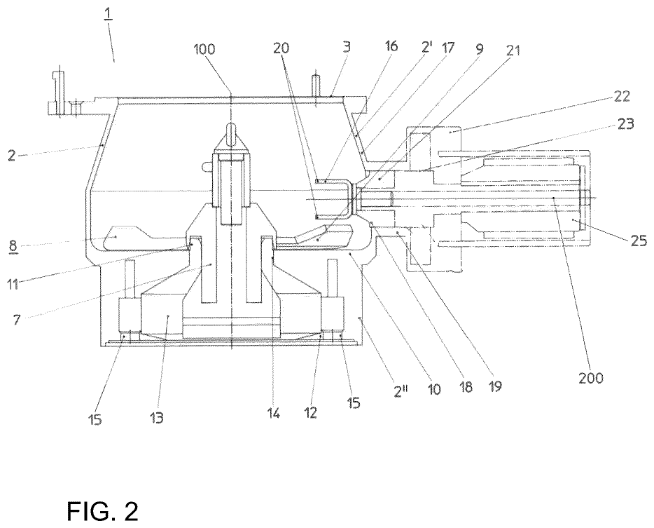

FIG. 2 shows the mixing granulator 1 with its components in detail. The shaft 7 of the mixing tool 8 extends vertically and centrally or concentrically in the vessel 2 (vertical mixer). The mixing tool 8 is seated on the shaft 7. The mixing tool 8 includes three blades 9 evenly spaced about an axis of rotation 100 of the shaft 7. The three blades 9 of the mixing tool 8 provide for the mixing of the raw materials (usually powder). The mixing tool is pushed onto the shaft from the end and screwed on via a fastening screw. The drive of the shaft is below the container 2 and is not shown here. The container 2 is cylindrical in a first region 2′, in which the material to be mixed is received, and tapers towards the top. In this first region 2′, the container 2 includes a bottom 10 with an opening 11 through which the shaft 7 of the mixing tool 8 passes. The blades of the mixing tool are located in close proximity to the bottom 10. The blades are positioned opposite the plane of the bottom 10 and are angled from the axis of rotation 100 to the radial direction.

A connecting region 2″ of the container 2 extends below the first region 2′. The connecting region 2″ has a penetrating opening 12 which adjoins the opening 11 in the base 10 of the first region 2′. In the penetrating opening 12 of the connecting region 2″ lies a coupling portion 13 of a coupling, which connects the shaft 7 with the drive not shown. The power transmission in the coupling is effected by a key. The mixing tool is driven by a three-phase motor whose speed can be adjusted by a frequency converter.

A sealing device 14, in particular a bushing, is inserted into the penetrating opening 11 of the base 10, which surrounds the coupling portion 13 on the outside and projects into the interior of the container 2 in the first region 2′ through the opening 11 in the base 12 and seals the shaft 7 of the mixing tool 8 with respect to the container 2. The sealing device 14 is preferably made of polytetrafluoroethylene (PTFE). The sealing device 14 seals the interior of the container from the exterior, so that the powders or substances contained in the container 2 cannot escape to the outside.

The container 2 is placed on a container holder not shown and preferably locked by a bayonet catch. For this purpose, the container 2 includes recesses 15 at the front in the connection region 2″.

The container 2 can be closed with the lid 3. The lid 3 is preferably a transparent plastic lid, which is removable and equipped with an O-ring. A sintered metal filter, not shown, is located on the lid as a degassing filter. Two holes in the lid, not shown, allow the addition of pelletizing liquid and the installation of a temperature sensor (optional).

In addition to the mixing tool 8, a comminution tool 16 engages in the space enclosed by the first region 2′ of the container 2. The comminution tool 16 is located in the region of the container wall 17. For this purpose, the container 2 includes an opening 18 in the container wall 17 with an adjoining flange 19. The comminution tool 16 projects through the opening 18. The comminution tool 16 is U-shaped, with the two legs 20 extending parallel to the axis of rotation 200 and each having sharp edges that have a chopping effect. For sealing purposes, a sealing device 21 is provided between the comminution tool 16 and the flange 19. The sealing device 21 is preferably a PTFE bushing. A bearing housing 23 with a seal, two ball bearings 24 and a plastic gear coupling 25 is attached to the container 2 by a tri-clamp connection 22. The drive is preferably provided by a frequency-controlled three-phase motor with belt drive and pneumatically actuated coupling, which is not shown.

The comminution tool 16 functions to comminute possible undesired agglomerates and rotates at a high rotational speed, which is significantly greater than the rotational speed of the mixing tool 8. The axis of rotation 100 of the mixing tool is perpendicular to the axis of rotation 200 of the comminuting tool 200, but it is also conceivable to arrange the comminuting tool in such a way that the axis of rotation is parallel or substantially parallel to the axis of rotation 100 of the mixing tool 8.

The container 2 is fed manually through the opening closed by the lid 3. The homogenization of the components to be mixed is generally performed by the mixing tool 8. The average mixing time should be at least 2 minutes. The comminution tool 16 can be used to shorten the homogenization time. If component lumps are present, the comminution tool 16 is used to break up agglomerates.

In the case where moist granules are produced, the material is wetted by granulating liquid, in particular by a free-flowing jet or by a spray jet. If a spray jet is chosen, the liquid is preferably added through a pressure nozzle or a two-stage nozzle. The principle of spray granulation is to convert starting products of fine powder to granular consistency into uniform granules. In this process, a suitable liquid is sprayed onto the mixed material from above in a finely atomized form by an injection device, which causes the particles to agglomerate. Subsequent drying fixes these agglomerates.

For pelletizing, an increased or high speed of the mixing tool 8 is required compared to the mixing process. The material circulates inside the container 2 more or less in the form of a ring. This movement is necessary to achieve rounding of the mixed product.

After the desired final result has been achieved, the finished product can be removed via a side discharge opening in the wall of the container in the first region 2′ (outlet), which is not shown. For emptying, the outlet can be opened while the mixing tool is rotating. In the case of smaller containers, it may be possible to separate the container from the container holder for emptying and to empty it by opening the lid.

The container 2 with the mixing tool 8 and the comminution tool 16 can be removed from the container holder without tools, for emptying (tipping out) and for replacement. To do this, the comminution drive is pneumatically disengaged, the fastening screw on the mixing tool is unscrewed and the container is released from the (bayonet) lock by turning it slightly. Repositioning takes place in reverse order.

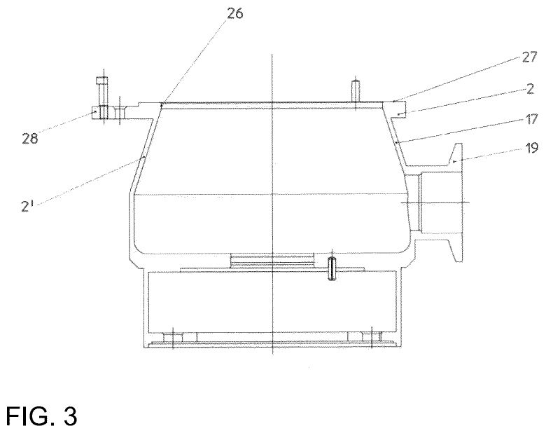

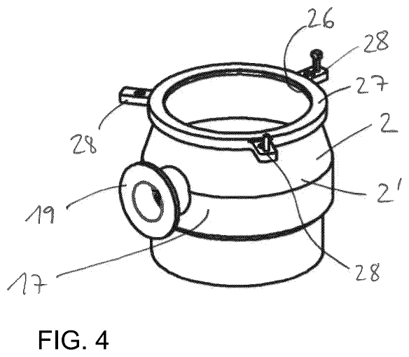

FIGS. 3 and 4 show the container 2 individually. The container 2 includes a circumferential rim 27 in the first, upper region 2′ adjacent to the opening 26 on the upper side, which is adjoined by fastening sections 28 in the radial direction to the central axis. The fastening sections 28 are evenly spaced in the circumferential direction. A total of three fastening sections 28 are provided. The fastening sections 28 serve to fasten the lid, which is not shown, to the container 2. In the assembled state, the lid rests on the rim 27. The container 2 does not have a spout, but this is optional. Also evident is the flange 19 arranged in the container wall 17 for the comminution tool.

In the preferred embodiments shown, the container 2 is preferably has a one-piece monolithic structure made of plastic.

In order to comply with the specified limit values of OEB, at least one of the parts in contact with the product is replaced and disposed of after each application. This means that most or all of the cleaning can be dispensed with. To make this possible in terms of cost, the part of the mixing granulator to be disposed of is made of plastic. If OEB 5 must be complied with and it is a high-containment application, this applies preferably to all parts in contact with the product. A major advantage of this design is the elimination of costly cleaning validation. Thus, any cross-contamination is excluded. This is particularly important for highly toxic materials.

The container can be formed in one piece. However, it is also conceivable that only parts of the container are made of plastic. In this case, the container can be multi-part or have integrated reinforcing elements, for example. Preferably, the container is injection molded. This also applies to the other parts to be disposed of or components that come into contact with the product.

The plastic used is suitable for use in the food and pharmaceutical sectors. It is food safe and food grade according to FDA or European regulations for food contacting materials (in particular (EC) No. 1935/2004, (EU) No. 10/2011), which materials meet the operational requirements.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A mixing granulator comprising:
a container to receive a product;
a mixing tool located in the container and seated on a vertically aligned shaft; and
a comminuting tool located in the container; wherein
at least one of the container, the mixing tool, and the comminuting tool that contact the product is at least partially made of a plastic or a plastic composite material.

2. The mixing granulator according to claim 1, wherein the container includes a first region to receive the product and includes a container wall and a base, including an opening for the shaft, and a connecting region adjoining the first region, which surrounds a coupling located between a drive and the shaft, the container including in the container wall in the first region a flange for the comminuting tool.

3. The mixing granulator according to claim 1, wherein the container has a single unitary structure made of a plastic or a plastic composite material.

4. The mixing granulator according to claim 1, wherein the plastic or the plastic composite is food-safe.

5. The mixing granulator according to claim 1, wherein the mixing tool includes blades and the comminuting tool is substantially U-shaped.

6. The mixing granulator according to claim 1, further comprising a base covering the drive of the mixing tool and a drive of the comminuting tool.

7. The mixing granulator according to claim 1, wherein the container is connected to the base via a bayonet connection.

8. The mixing granulator according to claim 1, wherein the first region of the container is sealed off from outside via a seal that seals the mixing tool and the comminuting tool.

9. A method of using the mixing granulator according to claim 1 for mixing pharmaceutical powder with aggregates.

10. The method according to claim 9, wherein the mixing granulator is used in a high containment application.

11. A container for a mixing granulator, the container comprising:
a first region to receive a product and including a container wall and a base;
an opening to accommodate a shaft of a mixing tool;
a connecting region adjoining the opening;
a flange located in the container wall in the first region to accommodate a comminuting tool; and
an opening opposite to the base and including a rim; wherein
the container is at least partially made of a plastic or a plastic composite material.

12. A method of using the container according to claim 11 for a mixing granulator for mixing pharmaceutical powder with aggregates.

13. The method according to claim 12, wherein the container is used in a high containment application.

14. A method of mixing substances with the mixing granulator according to claim 1, wherein the method comprises:
placing the substances in the container;
mixing the substances in the container using the mixing tool;
rotating the comminuting tool;
removing or discharging the product from the container; wherein
the at least one of the container, the mixing tool, and the comminuting tool that contact the product is discarded and replaced if a cleaning process is necessary to prevent cross-contamination.

15. The method according to claim 14, wherein the method is a high containment application and the at least one of the container, the mixing tool, and the comminuting tool is the container.
